(19) United States
(12) Patent Application Publication
(10) Pub. No.: US 2026/0349679 A1
(43) Pub. Date: Nov. 5, 2026

(54) DEPLOYABLE SOFTWARE GENERATION TOOL

(71) Applicant: Aboard Holdings, Inc., New York, NY (US)

(72) Inventors: Richard Ziade, Brooklyn, NY (US); Paul Ford, Brooklyn, NY (US); Adam Pash, South Pasadena, CA (US)

(73) Assignee: Aboard Holdings, Inc., New York, NY (US)

(21) Appl. No.: 19/199,309

(22) Filed: May 5, 2025

(51) Int. Cl. G06F 8/35; G06F 16/81

(52) U.S. Cl. CPC G06F 8/35; G06F 16/81

(57) ABSTRACT

A system for generating deployable software, the system comprising receiving, by a processor, a user request for a software application having at least one defined function; providing, by a processor, the user request and at least one additional contextual instruction for generating a manifest file, to at least one machine learning module, wherein the manifest file to be generated includes one or more parameters indicative of the functionality of the deployable software; generating the manifest file; providing, by a processor, at least the generated manifest file and the original user input to one or more machine learning modules, wherein the machine learning module is further configured to generate a deployable software package; and causing, by a processor, the deploying of the generated deployable software package in a software hosting environment.

### BACKGROUND

The use of Large Language Models (“LLMs”) to obtain answers for user queries and to generate code based on user prompts has seen incredible growth and adoption. Still, building complex, multi-layered software projects or systems that have a wide array of capabilities is not achievable with LLMs today. The process of software generation, even when it utilizes the capabilities of LLMs, still requires careful adjustments and combinations of code output by experienced engineers.

LLMs are generally excellent at generating content, offering impressive capabilities in creating custom documents like internal reports and memos. However, they can suffer from non-reproducible errors, such as hallucinating facts or providing code outputs that do not perform the desired functionality. These errors can be addressed through human review and iteration of generated content with minimal downside in document generation. However, as a result, it is technically difficult to generate complex software applications by simply making a request to an LLM.

Indeed, even when trained to generate code, LLMs can suffer from insufficient context windows, misalignment of functionality, or other errors that make it difficult to generate usable and deployable software applications directly from a user prompt(s).

Thus, what is needed in the art are systems, methods, and approaches for providing deployable software based on user prompts. Such approaches leverage the generative capabilities of LLMs but allow for a significant reduction in errors and a reduction in the time taken to in the process of providing new software using LLMs.

### SUMMARY

By way of overview, the systems, processes and computer implemented methods described herein are directed to approaches for the dynamic generation of executable or deployable software. A system is provided that includes at least one processor configured by code stored in a non-transitory medium to receive one or more user prompts, where the user prompts describe intended functionality of a software application. Using these prompts, the one or more processors are configured to transform the prompt into a collection of specific task items that are carried out by one or more suitably configured machine learning systems. These suitably configured machine learning systems are utilized to generate all or a portion of a software blueprint or manifest file that provides a detailed schematic for the data, routes, views and functionality of the deployable software. A software generation platform is configured to evaluate the manifest and provide users with access to the corresponding software

In one or more further arrangements, the software provided is automatically provisioned in a deployment environment for access by one or more users.

In one or more particular implementations, the software generation platform utilizes one or more machine learning systems to generate deployable software code based on the manifest file.

In an another implementation, a method for generating deployable software is provided, the method comprising: receiving, by a processor, a user request for a software application having at least one defined function; providing the user request and at least one additional contextual instruction for generating a manifest file to at least one machine learning module, wherein the manifest file to be generated includes one or more parameters indicative of the functionality of the deployable software; generating, by a processor, the manifest file; providing, by a processor, at least the generated manifest file to a software generation platform, wherein the software generation platform is configured to generate a deployable software package based on the generated manifest; and causing, by a processor, the deploying of the generated deployable software package in a software hosting environment.

In one or more particular implementations, the software generation platform is configured to provide the manifest and one or more additional data elements to one or more machine learning systems, wherein the machine learning system is further configured to generate the code of the deployable software based on the generated manifest.

In a further particular implementation, a system for generating and refining application manifests is provided, the system comprising: a user input module configured to receive a high-level user request; a multi-agent framework module comprising code executing in a processor to generate plurality of software agents, each software agent assigned to a specific task in the application manifest generation process; where the multi-agent framework module includes, but is not limited to, a role-based access control (RBAC) module configured to define roles and permissions based on the user request; a data model planning module configured to generate data models; a controller and API design module configured to generate API endpoints and controller actions; a UI and layout generation module configured to generate UI components and layouts; and an iteration and refinement module configured to iteratively refine the application manifest based on user input and automated self-evaluation.

In a particular implementation, the manifest file generated by the described system allows for the generation of a fully structured application manifest through a multi-agent, iterative, and user-driven refinement process.

### BRIEF DESCRIPTION OF THE DRAWINGS

The accompanying drawings illustrate several embodiments and, together with the description, serve to explain the principles of the invention according to the embodiments. It will be appreciated by one skilled in the art that the particular arrangements illustrated in the drawings are merely exemplary and are not to be considered as limiting the scope of the invention or the claims herein in any way.

FIG. 1 is a schematic diagram of the components of an implementation of the system described.

FIG. 2 is a schematic diagram of one or more software modules or elements of the system described.

FIG. 3 is a flow diagram of the process of software generation according to one or more implementations of the system described.

FIG. 4 is an example of a portion of the manifest file in accordance with one or more implementations of the system described.

### DETAILED DESCRIPTION

By way of overview, the systems, processes and computer implemented methods described herein are directed to generating or providing access to a custom software application. In one arrangement, a processor is provided to receive one or more user prompts, where the user prompts describe intended functionality of the software to be generated. Using these prompts, one or more processors are configured to transform the prompt into a plan for a corresponding software application. In one arrangement, this plan is generated by one or more suitably configured and instantiated machine learning systems. In a particular approach, this machine learning system is further configured or instructed to delegate collection of specific task items that are carried out by one or more suitably configured machine learning systems. These suitably configured machine learning systems are utilized to generate content for integration into a manifest file that provides a detailed schematic of deployable software that is configured to carry out the intended functionality.

Using the manifest file, a software generation platform is configured to connect the user's proprietary database and provide the application to the intended users. In one particular implementation, the software generation platform is configured to interpret the contents of the manifest file and produce the necessary views and functionality. In one or more alternative arrangements, the manifest file is provided to one or more machine learning or artificial intelligence systems. These systems evaluate the contents of the manifest file and generate one or more software files that provide the generated software. In yet a further arrangement, the generated software is automatically provisioned in a deployment environment for access by one or more users.

Such an approach represents an improvement in the technical field of AI assisted code generation. LLMs typically display creative behavior. However, the drawbacks to using LLMs include hallucinations and other errors, often times subtle, that are provided in the output content. The described approach provides an improved approach that leverages the generative capabilities of LLMs while providing a structured workflow. In part, by using one or more LLMs to transform the user's input or request into a manifest file, the present approach generates a framework for the software to be evaluate or generated.

The inventors have found that generating a manifest file that serves as the blueprint for the actual software generation process reduces the errors generated by the LLM. Furthermore, with the advent of LLMs using chain of thought reasoning, the generation of a manifest file provides an intermediate reasoning locus for the LLM prior to generating and deploying the software. That is, the current approach provides the manifest file as a locus of focus for the LLM to reason. As such, the presently described systems, methods and computer implemented processes are directed to transformations, using one or more machine learning systems of received user prompts into a structured manifest file, such as a declarative JSON file.

The described approaches provide for a more efficient process that includes fewer errors and less resource utilization to achieve a similar output to existing AI systems.

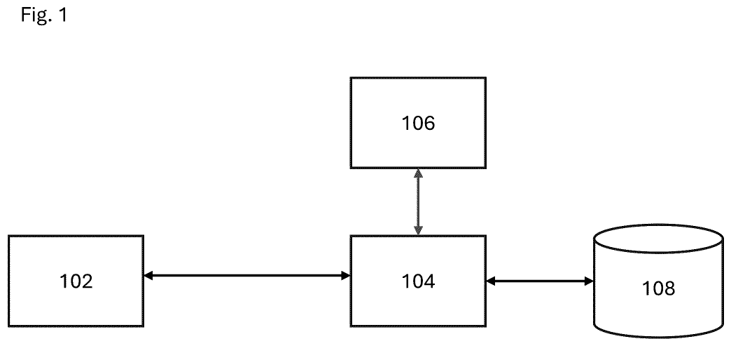

As shown in FIG. 1, a user input device 102 is configured to exchange data with a software generation server or platform 104. In one or more implementations, the user input device 102 is a smartphone, tablet computer, desktop, laptop, workstation or other computing device. In one or more arrangements, the user input device includes one or more keyboard, input devices, touch screen interfaces, voice interfaces or other known and understood interface devices. In one or more implementations, the user input device 102 is configured to communicate using one or more wired or wireless protocols, such as ethernet, WiFi and Bluetooth.

In one implementation, software generation server 104 is a commercially available computing device. For example, software generation server 104 may be a collection of computers, servers, cloud functions, AWS clusters, containers, microservices, microprocessors, micro-computing elements, computers-on-chip, prototyping devices, or “hobby” computing elements.

The software generation server 104 and/or the user input device 102 are configured to execute a commercially available or custom operating system, e.g., Microsoft WINDOWS, Apple macOs, UNIX or Linux based operating system, in order to carry out instructions or code.

The software generation server 104 and/or the user input device 102 may include one or more memory storage devices (memories). The memory is a persistent or non-persistent storage device (such as an IC memory element) that is operative to store the operating system in addition to one or more software modules. In accordance with one or more embodiments, the memory comprises one or more volatile and non-volatile memories, such as Read Only Memory (“ROM”), Random Access Memory (“RAM”), Electrically Erasable Programmable Read-Only Memory (“EEPROM”), Phase Change Memory (“PCM”), Single In-line Memory (“SIMM”), Dual In-line Memory (“DIMM”) or other memory types. Such memories can be fixed or removable, as is known to those of ordinary skill in the art, such as using removable media cards or modules. In one or more embodiments, the memory of software generation server 104 provides for the storage of application programs and data files. One or more memories provide program code that the software generation server 104 and/or user input device 102 reads and executes upon receipt of a start, or initiation signal.

As further shown in FIG. 1, the software generation server 104 is configured to store data either locally in one or more memory devices. Alternatively, software generation server 104 is configured to store data, such as device data and operational data (such as decision tree data and training data as well as processing results) in a local or remotely accessible database 108. The physical structure of database 108 may be embodied as solid-state memory (e.g., ROM), hard disk drive systems, RAID, disk arrays, storage area networks (“SAN”), network attached storage (“NAS”) and/or any other suitable system for storing computer data. In addition, database 108 may comprise caches, including database caches and/or web caches. Programmatically, database 108 may comprise flat-file data store, a relational database, an object-oriented database, a hybrid relational-object database, a key-value data store such as HADOOP or MONGODB, in addition to other systems for the structure and retrieval of data that are well known to those of skill in the art. Database 108 includes the necessary hardware and software to enable processor 108 to retrieve and store data within database 108.

As also shown in FIG. 1, a machine learning appliance 106 is also provided. In one or more implementations, the machine learning appliance 106 is a locally controlled or constructed large language model. In another implementation, the machine learning appliance 106 is a remote server, software system, computing group or cluster that provides access to one or more AI systems. For example, in one or more implementations, the machine learning appliance 106 is accessible by the software generation server 104 through one or more application programming interfaces (API). For example, the machine learning appliance 106 is a server operated by OpenAI, Google, Meta or another provider of AI as a service.

In addition to the aforementioned configurations, the machine learning appliance 106 can be integrated with various data processing modules to enhance its functionality. These modules may include data pre-processing units, feature extraction tools, and model evaluation components. The integration of these modules allows the machine learning appliance 106 to perform complex data analysis tasks, thereby improving the accuracy and efficiency of the AI systems it supports.

Furthermore, the machine learning appliance 106 can be configured to support real-time data processing and analysis. The appliance's ability to handle large volumes of data in real-time ensures that it can meet the demands of high-performance computing environments.

Moreover, the machine learning appliance 106 is designed with scalability in mind. It can be easily scaled up or down based on the computational requirements of the AI systems it supports. This flexibility ensures that the appliance can adapt to varying workloads and maintain optimal performance levels. Additionally, the appliance can be deployed in a distributed manner, allowing multiple instances to work together seamlessly, thereby enhancing its overall processing power and reliability.

In one particular implementation, the machine learning appliance 106 includes a natural language processor. For example, the natural language processor is configured to receive textual input from the software generation server 104 and evaluate the textual input for the purpose of analyzing and extracting meaning and information from the textual input. For example, and in no way limiting, data such as text or voice data provided by the user input device 102 can be routed to the machine learning appliance 106 for further evaluation and analysis.

In one or more arrangements, the machine learning appliance 106 includes one or more large language models. It will be understood that as used herein, large language models (LLMs) are machine learning models that can be trained on data sets of content to generate flexible customized outputs suitable for a number of tasks, including generating software code, creative or informative text, images, or data. In particular, various implementations described herein provide one or more large language models (LLMs) for a variety of different natural language processing (NLP)-related tasks, such as generating content for integration into a software manifest file or document.

In one or more further implementations, the machine learning appliance 106 is configured to be adaptable for use with a variety of tasks such as generating custom software modules, JSON data, API calls, code documentation, and content for integration into manifest files without a need to retrain the core or base model or use multiple different, customized models. For example, the LLMs provided by the machine learning appliance 106 are configured such that custom or individual prompting guidance provides for a focused context for the LLM to operate. Here, such prompting guidance can include one or more token, tag, weight, file, modifier, or other type of data object that can be added to, embedded in, or associated with a request to perform a specific operation, or type of operation, with respect to a string of text.

As a non-limiting example, prompt tokens can be used to train or instruct the LLM to indicate the nature of the operation to be performed, retrieval set tags can be supplied to the LLM to indicate a data set to use for the operation, and/or adaptor weights can be used that can effectively modify operation or structure of the language model. In one or more further arrangements, the machine learning appliance 106 includes software utilized to set these prompt tokens, or otherwise retrieve and pre-process data for submission to the LLM as well as receiving and transmitting the output.

Returning to the overview, each element provided in FIG. 1 is configured to communicate with the others through network connections or interfaces, such as a local area network (LAN) or data cable connection. In an alternative implementation each of the elements depicted are connected to a network, such as the internet, and are configured to communicate and exchange data using known and understood communication protocols.

Those possessing an ordinary level of skill in the requisite art will appreciate that additional features, such as power supplies, power sources, power management circuitry, control interfaces, relays, adaptors, and/or other elements used to supply power and interconnect electronic components, and control activations are appreciated and understood to be incorporated.

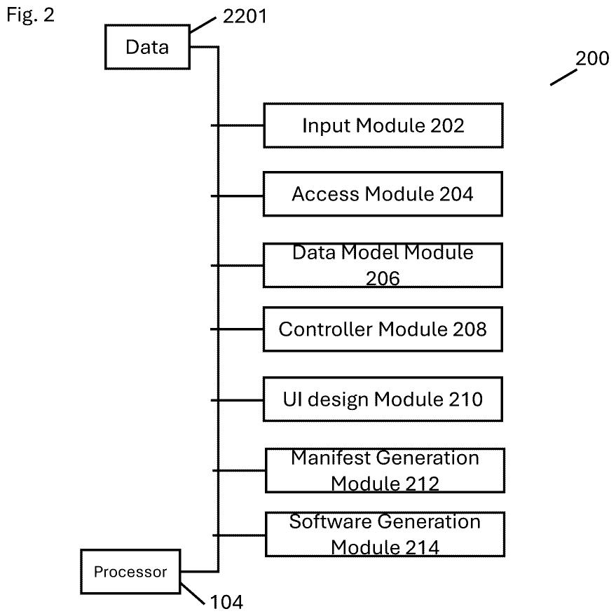

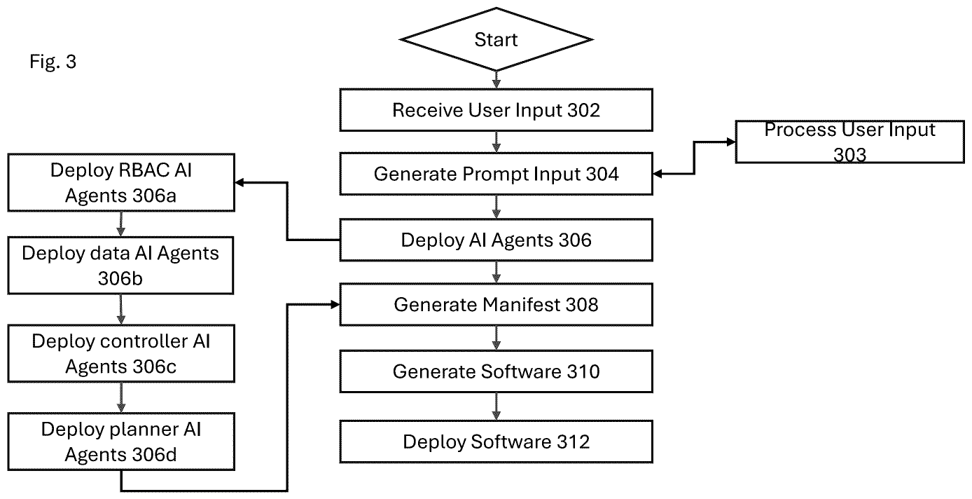

Turning now to FIGS. 2 and 3, by way of overview and introduction, the present described systems, methods and computer implemented processes are directed to approaches for generating deployable software using one or more software-directed systems. In particular, the approaches described allow for a user to input broad functional requirements for deployable software. Taking these functional requirements, software mediated agents, such as software agents directed by a large language model (LLM) or other artificial intelligence systems, are able to plan and generate the necessary manifest file(s) for the generation of deployable software. By utilizing software-directed or AI agents, the process of translating broad functional requirements into deployable software is significantly expedited. These agents, powered by LLMs or other AI systems, are capable of interpreting user inputs and autonomously generating detailed manifest files. These manifest files serve as blueprints, outlining the necessary components and configurations required for the software deployment.

Once the manifest file(s) is generated, the software generation platform or server 104 is configured to interpret the JSON contents therein and produce the necessary files and other assets necessary to host, compile, or deploy the generated software. In one arrangement, the software is deployed to a web environment such as a web application.

By way of continued overview, the presently described system first generates a manifest or blueprint file that is used by the software generation platform. To generate this blueprint, a machine learning system is configured to first generate a plan to implement the user's request. This plan can be provided to the user, or utilized and evaluated only by an LLM. This manifest generation plan is utilized by the LLM to maintain focus on the task request, and provides different areas of focus for AI agents. For example, the AI agents are directed to evaluate a collection of internal and external resources to generate the necessary content for inclusion into the manifest or blueprint file.

As described in more detail herein, the user input is processed and provided to the machine intelligence system. This machine intelligence system is configured to provide follow-up questions and provide responses to the user to determine the scope and format of the custom software. For example, and in no way limiting, where the custom software is a human resource management system, the machine intelligence system can ask the user to clarify the relationship between the employees.

For example, AI agents are directed to take specified actions within a functional group. For instance, an AI system tasked with generation of a user interface for the custom software is configured to deploy one or more AI agents to take into account the custom business logic specified by the user or company specific internal policies or procedures. In turn, these AI agents will generate the necessary content (such as in the form of text-based data format, such as a JSON document) that corresponds to the desired UI.

By way of further overview, the software generation system described provides for a plurality of supported operations or modules (as discussed in more detail herein) that are implemented when generating the manifest file. These operations instruct the AI system(s) as to which AI agents are to be utilized for a given task relating to the generation of all or part of the manifest file.

For example, the machine learning system generates a plan for generating JSON code or content that corresponds to a particular component of the software, such as the UI elements. Using this plan, the machine learning system is configured (by content supplied by both the user input and data generated or accessed by the software generation system) to route information on specific aspects of the plan to different artificial intelligence agents. By way of non-limiting example, the AI UI agent is configured to generate JSON content in the form of a schema for a field to be displayed during the operation of the software. Likewise, the AI agents are tasked with creating specific rules, such as when and how then users are able to dynamically respond to the API. In one arrangement, these rules are based on the scope of the API. However, in some arrangements, the manifest is constructed so as to permit only a sub-set of actions using a supported API.

In a further arrangement, it may be necessary to add additional content to the manifest file. Here, the user can evaluate the manifest file and query the described system to generate new content for inclusion into the model. For example, the user can request the addition of a new data model. The machine learning system (referred to as a dispatcher) first provides the model request to a model agent, and the model agent generates the new content (here a data model) and adds it to the manifest file. In one or more implementations, the machine learning system also includes one or more validation functions that make sure any added content matches the user's intent.

Once the manifest file has been generated, it can be evaluated by one or more validation systems. For instance, the generated manifest file is in the form of a declarative JSON document. Thus, the structure and content of the manifest can be validated against a reference framework to confirm that the machine learning systems have generated additional content that meets pre-determined conventions and formats.

Furthermore, once the manifest file has been generated, the manifest file can be updated based on user feedback. In particular, because the manifest file does not generate code, it is then possible to update data models, UI views and specific fields in the custom software without the need to regenerate the entire manifest file.

Additionally, custom business logic for a given use case can be introduced into the manifest file. By way of non-limiting example, the user can add JSON content to the manifest so that when the software is deployed, specific functionality can be implemented.

It will be appreciated that such a software generation system represents an improvement in the functioning of computers and improves the process of generating custom software. While in existing systems, a developer could manually generate a declarative JSON manifest file, such a process is both time consuming and potentially prone to human error. Instead, by leveraging one or more machine learning systems to evaluate the user input and generate the manifest, the time and resources needed to generate deployable software can be dramatically reduced.

Once the machine learning or AI intelligence system has generated the content (such as JSON data) this data is then included into the manifest file. The manifest file can be used to generate the deployable code. In one or more implementations, the software generation platform 104 is configured to evaluate the manifest file and generate the HTML and view code necessary to allow users to interact with the application. In one arrangement, the HTML code generated includes JavaScript or other scripting code to implement certain functionality described in the manifest file. In a further arrangement, the database 108 includes all of the data that is utilized by the application. For example, where the custom generated software is an HR management system for a firm, the database 108 is a relational database that includes data about the employees, such as their titles, direct reports, locations, salaries, and other pertinent data. The software generation system evaluates the manifest file to generate the view code and provides access to the database to populate the generated application while in use.

In a particular example, the software generation platform 104 receives the manifest file and in turn provides access to a web-based application that corresponds to the functionality, data organization and presentation provided for in the manifest file. In this configuration, there is no need to generate corresponding code files for the web application. Instead, the software generation platform 104 is able to interpret and present the manifest file as a web accessible application. For example, the software generation platform is configured by one or more deployment modules to read the JSON of the manifest file and dynamically generate the html and other view code necessary for users to interact with the data stored in the database 108.

However, in one or more further implementations, the software generation platform is configured to parse the contents of the manifest file and render or generate code based on the contents. In one or more implementations, the software generation platform is configured to generate the necessary code corresponding to portions of the JSON file based on one or more templating engines that receive JSON content and generate code in HTML, JavaScript, CSS, python, Rust, Go, PHP, Ruby or other files and formats.

In an alternative configuration one or more machine learning or AI systems generate the code, files, and other assets required for a functional version of the deployable software. This phase may involve the same AI system or a different one, from the system that generated the manifest file depending on the complexity and requirements of the project. The AI system ensures that the generated code adheres to the specified functional requirements and is optimized for performance and scalability. This automated approach reduces the need for extensive human intervention, thereby minimizing errors and accelerating the development process.

Turning now to one or more specific examples of particular implementations or configurations of the systems, methods and computer implemented processes described, one or more of the processors of the software generation server 104 may access individual code components or modules. As used herein, the code modules are uploaded to all or portions of the memory program memory of the software generation server 104, and the processors of the software generation server 104 are configured to execute machine instructions or scripts associated with the uploaded program.

By way of non-limiting example, such described modules are written using Python scripts, which then are invoked to execute the herein disclosed methods. The Python scripts work together to retrieve, process, and analyze data retrieved or accessed from one or more data sources 2201. In one or more arrangements, the processors of the software generation server 104 may use various libraries such as os, json, pathlib, time, requests, Ixml, csv, pandas, pinecone, dotenv, openai, embedding, and more to process input data, pass instructions to one or more machine learning systems or to receive, format and output data received from the machine learning systems.

FIG. 2 illustrates an example computer program executable to implement the herein disclosed artificial intelligence systems. In FIG. 2, computer program 200, which may be stored on non-transitory computer-readable storage medium, includes at least a user input module 202, a roles-based access control module 204; a data model generation module 206; a controller design module 208; and UI design module 210.

As shown in FIGS. 2 and 3, in one embodiment of the described systems, the user initiates the process by providing a high-level request, such as “I want to build a customer relationship management software.”

Here, it will be appreciated that in one or more implementations, the user request is made through the use of the user input device 102. For example, the user input device is configured with a local application that establishes a communication link with the software generation server 104. In alternative implementations, the user input device is able to access a custom web page that allows for the exchange of data with the software generation server 104.

In one arrangement, as shown in step 302, the user inputs this request as a prompt that will be provided to the software generation server 104. Here, the software generation server 104 is configured by one or more input modules 202 that configure a processor of the software generation server 104 to process the user input. For example, the input module 202 can configure a processor of the software generation server 104 to pre-process the user input. The user input can be provided to one or more NLP sub-modules that convert the user's request into a standardized format.

Using the above example, step 303 provides that when the user submits a request that states, “I need software to help me organize my customers” one or more submodules of the user input module 202 take this input and process the original input and convert that prompt into a standardized software class, such as “the user is requesting a CRM solution”.

Alternatively, the one or more submodules of the input module 202 can provide the user input to one or more LLMs. Here, the sub-modules are configured to determine if additional context is necessary in order to carry out the software generation request.

However, in another configuration, a processor of the software generation server 104 is configured by the user input module 202 to pass the user input to one or more conditioning LLMs or natural language processing models that convert the user input into both the original user input and one or more context prompts that accompany the user input.

For example, and in no way limiting, where the user input is a request for a CRM system, the user input module 202 is configured by a processor of the software generation server 104 to combine the user input with one or more context documents designed to elicit from the LLM the desired output. For example, the user input module 202 configures such a processor to provide additional context, such as the desired form of the output, additional parameters for considerations, and other information that might be utilized by the described system to generate the deployable software.

It will be appreciated that the additional context provided as part of the user input module 202 processing and transforming of the user input serves to aid in the extrapolation from the simple request (“provide a CRM program”) into specific functionalities and features that the desired software application should possess, without the user needing to intervene. For example, the user input module 202 configures a processor of the software generation server 104 to include within a generated context, that the output of the LLM should be in a form suitable for inclusion into a JSON manifest file. However, other file types such as XML are also understood and envisioned.

In one arrangement, a processor of the software generation server 104 is configured by a user input module 202 to receive the user input and generate one or more prompts that will be provided to a machine learning system. For example, the user input is combined in a data object with one or more contextual prompts or instructions to the intended destination LLM. In one arrangement a processor of the software generation server 104 is configured by the user input module 202 to automatically access one or more data stores of pre-written context content for combination with the user input.

As noted, the user input module 202 configures a processor of the system to leverage one or more natural language processing (NLP) techniques to understand the user's intent and extract relevant information from the request. This initial analysis sets the stage for subsequent steps, ensuring that the system accurately comprehends the user's needs.

In connection with the development of a manifest or plan document, the software generation server 104 provides additional context beyond the user input. As noted, the elements of a software application are varied, but can be generalized into different functional groups, such as access control, data modeling functions, controller functions, and user interface functions. Thus, in one or more implementations, the additional prompt context provided to the operating LLM includes data and information useful in architecting these functions within the overall scope of the deployable software to be generated, as shown in step 304.

In one arrangement, the prompt supplied by the user input module 202 is also configured to cause the activation, or instantiation of one or more software agents as shown in step 306. Here, the software generation server 104 is configured to communicate with the machine learning appliance 106 and send both the user input (either original, reformed or both) along with additional data. Here the additional data includes instructions to the machine learning appliance 106 to utilize a collection of AI agents, and to assign each of the AI agents a specific task in connection with the development of the software.

As used herein, an AI agent is a software entity that autonomously performs tasks or makes decisions based on data inputs, algorithms, and predefined rules. It can learn from its environment, adapt to new information, and interact with other systems or users to achieve specific goals.

The integration of AI-driven agents in the software development and deployment process offers numerous advantages, including increased speed, accuracy, and consistency. By automating the generation of manifest files, code, and deployment tasks, the described systems and methods provide a robust framework for developing high-quality software. This approach not only improves the functionality of the LLMs, but also represents a solution to a problem rooted in computer technology.

For example, the software generation server 104 is configured by a role-based access control module 204 to generate the necessary instructions for a machine learning appliance 106 to generate or deploy a multi-agent team tasked with defining roles and permissions of the desired software, as shown in step 306a.

By way of background, such approaches are typically referred to as a Role-Based Access Control (RBAC). It will be appreciated that RBAC is an access control mechanism used in software applications to manage user permissions. Instead of directly assigning permissions to individual users, RBAC introduces the concept of “roles.” A role represents a collection of permissions that are logically grouped together based on job functions or responsibilities within the software system. Each role defines what actions users assigned to that role are authorized to perform within the application, such as viewing, creating, modifying, or deleting specific data or functionalities. This approach creates an abstraction layer, simplifying the management of permissions by associating them with roles rather than individual user accounts.

In one arrangement, the software generation server 104 is configured by a role-based access control module 204 to instruct a machine learning system to generate a plan for implementing the described functionality. Part of the data provided to the machine learning system by the software generation server 104 includes directions to delegate certain tasks to one or more software agents. For example, the software generation server 104 is configured by a role-based access control module 204 to provide additional context, beyond the request to generate RBAC schema. These additional contexts can include instructions on how to delegate specific aspects of the generation of the RBAC schema to different AI agents based on pre-defined roles. For example, the user input module 202 can pass one or more requirements and objectives, including roles, permissions, and any specific rules or constraints to the role-based access control modules 204. From there, the role-based access control module 204 configures the software generation server 104 to access a data repository or data storage (such as data repository 2201) that includes information such as user roles, access levels, and existing access control policies.

This information is provided to the machine learning appliances 106 for generation of a plan to implement the desired RBAC schema and to delegate specific or general tasks to one or more AI agents and the evaluation of the data.

The generated agent is configured by the context provided by the role-based access control module 204 to utilize algorithms, which may include machine learning models, rule-based systems, or optimization techniques, to analyze the data and generate some or all of a draft RBAC schema. This schema outlines the roles, permissions, and access rules for the software project. In one particular example, the team of AI agents is responsible for creating a structured RBAC schema that adheres to industry standards and best practices. The agents within the team collaborate to identify the various roles required for the software application and the corresponding permissions associated with each role. This process involves analyzing the application's use case and determining the access control requirements for different user groups. In one arrangement, one or more AI agents can access a relational database to determine the different roles within an organization.

In one arrangement, the generated RBAC schema is passed back to the user for comments and analysis. However, in a particular implementation described herein, the software generation server 104 is configured by the role-based access control module 204 to receive the generated RBAC schema, but provide the generated schema along with the original context back to a suitably configured machine learning appliance 106. Here, the machine learning appliance 106 is instructed to evaluate the generated RBAC schema and confirm that the generated schema is in compliance with the data and user input provided.

As described, in one or more further implementations, the portion of the RBCA schema generated by the AI agents can be validated. This validation includes evaluating the generated RBAC schema against a template or form RBAC schema for the type of software to be generated. In this way, the machine learning system configured to provide the RBAC schema is able to determine if the generated schema meets the user's requirements and conforms to protocols and standards.

For example, the RBAC schema is iteratively provided to one or more machine learning appliances 106 that delegates one or more AI agents to review RBAC schema. These agents review the RBAC schema to ensure that it accurately reflects the intended access control policies and that it is free from any inconsistencies or security vulnerabilities. This iterative process continues (that is, the AI agents providing updates to the RBCA schema and providing those to the software generation server 104 for incorporation into the manifest file) until the schema meets all predefined criteria.

Once an optimal RBAC schema has been generated, it is incorporated into the manifest file or stored for future use. For example, the manifest file module 212, configures the processor of the system described to generate a manifest file from data inputs. Here, such data inputs can include the RBAC schema generated by the RBAC agents. In one arrangement, the generated schema is stored in an accessible data repository.

However, in one or more alternative implementations, the AI agents tasked with generating a structured RBAC schema are configured or instructed by the software generation server 104 to first access a collection of previously generated RBAC schema. For example, the software generation server 104 is configured by the access module to identify RBAC schema that is intended for integration into software having the same or substantially similar functionality as the user request. By way of example, if the user request if for a “CRM solution for a tax firm” the software generation server 104 is configured to identify previously generated and validated RBAC schema for tax firms, and provide those previously generated schema for review by the machine learning appliances 106. Using these previously generated and validated RBAC schemas, the overall process of software generation is made faster and more reliable while also using less resources.

While the foregoing example identifies a premade RBAC schema or component, it will be appreciated and understood that other schema and software components can be selected from a stored library of components. In particular, the machine learning appliance 106 is configured by the user input and one or more contextual prompts to select one or more pre-made schema for integration into the manifest file.

Continuing now with step 306b, the software generation server 104 is configured by a data model module 206 to cause the deployment of a machine learning appliance 106 configured to plan data models for use in the generated software. As with the RBAC AI system, the data model AI system is configured to generate a plan for constructing the appropriate schema for the data models. Here, the data model AI system is instructed or prompted by a software generation server 104 configured by a data model module 206 to delegate the generation of the proper schema for the data models to one or more AI agents. Here, the AI agents are delegated to generate the data modules for use in the generated software. For example, the delegated AI agents are tasked with generating the schema for data modules that will control the flow of information through the generated software. In one arrangement, a planning agent is delegated the responsibility to generate data models based on the plan developed by the data model AI system. Here, the planning agent is instructed to request information on the necessary data models (e.g., Leads, Contacts, Deals). Such data can be provided by the software generation server 104 configured by a data model module 206. Alternatively, the AI agent is configured to access the data repository 2201 for additional information about the data models.

In yet a further implementation, the data model AI system is instructed (such as by the software generation server 104 is configured by a data model module 206) to cause the generation of another AI agent, a decomposition agent. Here, the data model AI system delegates to the decomposition agent a task to structure the data models into logical entities and the accompany schema representing the structure of the data. In a further arrangement, another AI agent, a generation agent, is delegated the task to produce JSON representations of the models and validate these models against predefined schemas. In yet a further arrangement, an evaluation agent is also delegated and instructed to check for completeness, and coherence, of the generated data (in JSON schema) by the other AI agents.

Here, the evaluation agent is instructed to refine the schema representing the models as needed. Depending on the output of this initial review, the software generation server 104 is configured by a data model module 206 instructs the data model AI system to evaluate the JSON representations of the models through an evaluation and refinement process. For example, data model AI system iteratively evaluates the responses generated by the machine learning appliance 106. Where refinements are required, the data model AI system is delegated to a specific AI agent to modify the JSON schema until an optimal schema and structure are achieved.

As with the RBAC agent team output, the output of the data model AI system team is also provided to the manifest file module 212 for inclusion in the manifest file.

Turning now to step 306c, in one or more implementations, the software generation server 104 is configured by a controller module 208 to instruct or prompt a planner AI system. The planner AI system is instructed to generate a plan to carry out the task of generating necessary API endpoints and CRUD (Create, Read, Update, Delete) operations for the generated software.

The planner AI system is further instructed to delegate to a decomposition agent the task of breaking down this plan into individual controller actions, ensuring logical grouping of routes and handlers. For example, a planning agent is delegated to analyze the data models and user requirements to determine the necessary API endpoints and CRUD (Create, Read, Update, Delete) operations. This analysis involves identifying the specific actions that the API needs to support and defining the corresponding endpoints.

The planner AI system is further instructed to delegate to one or more generation agents to the task of producing produce a structured JSON representation of API endpoints. By way of non-limiting example, the structured JSON representation generated is configured to handle authentication, request validation, and response formatting.

The planner AI system is further instructed to delegate to one or more evaluation agents the task of checking for consistency in access control rules, data validation, and adherence to best practices. For example, the evaluation agent is able to access one or more data stores (such as datastore 2201) that provide frameworks or data relating to the controls, rules and best practices and compare these to the generated schema of the planner AI system.

As previously provided, in one or more implementations the described agents are, in one arrangement, large language models. As such, the data stores accessed become additional context used to reason about the user's request. For example, where the evaluation agent is used to generate representations based on best practices, the agent is able to access a data store of best practice documents and reason to the principles described herein. As such, the utilization of agents in this manner represents an improvement over a traditional expert system. In part, this improvement in functionality comes from simplifying the data sources. In a traditional system, the best practices and rules were hardcoded into the system. Using AI agents allows for unstructured data such as white papers or policies to be provided to the context window of the agent and the agent is then able to reason using that context.

Returning to the planner AI system instructed by a software generation system configured by a controller module 208, once the API design has been generated by the AI agent team, it is then reevaluated in light of the user input and materials provided. Where refinements are required, the process loops iteratively until the API design meets all functional and security requirements.

As with the prior agent teams, the output of the controller agent team is also provided to the manifest file module 212 for inclusion in the manifest file.

Turning now to step 306d, the software generation server 104 is configured by a planning module 210 to instruct or prompt the machine learning system 106 to generate a user interface (UI) plan. For example, the machine learning system is configured to generate a plan for a user interface for the generated software. The machine learning system 106 is further instructed or prompted to delegate the actions to carry out the plan to one or more UI focused AI agents. Here, a UI planning agent is delegated with the task to determine the UI components, layouts, and user flows based on the application's use case and defined roles. In one arrangement, the AI agents are delegated or instructed to access the outputs of the other AI agent teams. For example, the planning agent is provided with the output of the controller agent team, the RBAC team or the planning team. In a further arrangement, a decomposition agent is delegated to evaluate the UI plan and generate one or more logical views and components, considering user interactions and navigational flows. Similarly, the planning module 210 configures a processor of the software generation server 104 to instruct the machine learning system to delegate to a generation agent to create one or more JSON-based UI definitions. Here, the UI definitions can include forms, tables, dashboards, and interactive elements.

In one or more further arrangements, the planning module 210 configures a processor of the software generation server 104 to prompt or instruct the machine learning system to delegate to a testing agent the task of conducting reviews of the UI for usability, role-based restrictions, and consistency with business logic.

In one or more implementations, the planning module 210 configures a processor of the software generation server 104 to prompt or instruct the machine learning system to delegate to a generation agent the task of creating one or more JSON-based UI definitions, including forms, tables, dashboards, and interactive elements. These definitions are designed to be consistent with the application's business logic and role-based restrictions. In yet a further arrangement, the planning module 210 configures a processor of the software generation server 104 to prompt or instruct the machine learning system to delegate to a generation agent the task of reviewing the generated UI for usability, ensuring that it meets the needs of the end-users and adheres to best practices. If any refinements are necessary, the AI agents are configured to iterate through improvements until the UI structure is fully optimized.

For example, each individual AI agent is tasked with validating or revising specific UI schema content and evaluating it against one or more stored templates, or best practices documents. By way of further example, the planning module 210 configures a processor of the software generation server 104 to prompt or instruct the machine learning system to delegate to a generation agent the task of creating structured JSON representations of the API endpoints, incorporating authentication mechanisms, request validation, and response formatting. Additionally, an evaluation agent is delegated with the task of reviewing the generated API design for consistency in access control rules, data validation, and adherence to best practices. If any issues are identified, the process loops iteratively until the API design meets all functional and security requirements. The final API design is then integrated into the system, providing a robust interface for interacting with the software application.

As with the prior agent teams, the output of the UI agent team is also provided to the manifest file module 212 for inclusion in the manifest file.

It will be appreciated that additional AI planners, agents and teams of agents can be used to generate additional content for the manifest file. For example, where the software request is a video game, the system described includes specific agents to handle video game controller inputs, game loops and engines and other task specific functionality, so long as these functions can be represented in the manifest file. Thus, the process and system described herein are not limited to the AI agent teams provided in the detailed embodiments but can be extended to teams for other and varied tasks.

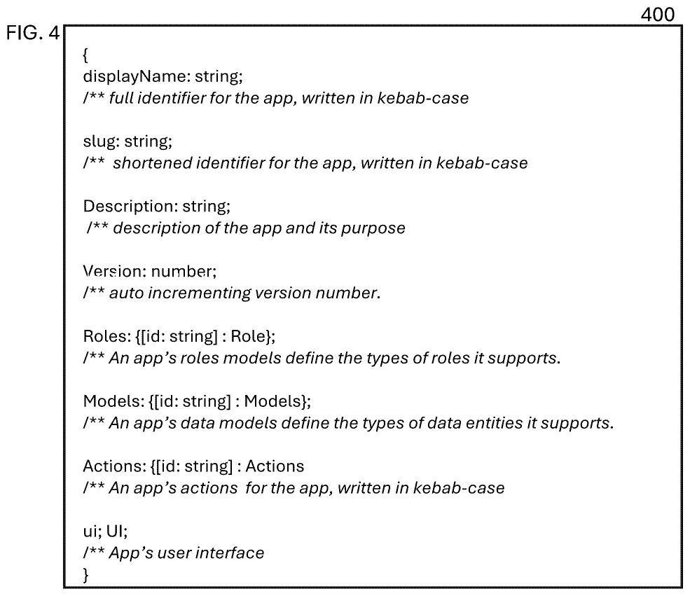

Once the machine learning systems, or AI agents have generated and validated their respective JSON schema, those schema can be integrated into a template manifest file. As shown in FIG. 4, a manifest file (400) includes distinct areas corresponding the models, views, routes, and other data objects that correspond to structure of the software to be rendered or generated.

In one arrangement, the software generation server 104 is configured by a manifest file module 212 to generate a manifest file based on the output of the agent teams, as shown in step 308. It will be appreciated that by using the output of the AI teams to generate the JSON manifest, the described platform is configured to generate a fully scoped and detailed application without first generating code.

It will be appreciated that the software generation server 104, and/or the machine learning appliance 106 are configured to dynamically process the manifest file (here in JSON format) to produce software application can is accessible to one or more users, where the software provided has defined data models, business logic, role-based access control (RBAC), and user interface (UI) components developed in steps 302-306d, facilitating the rapid deployment and utilization of a functional applications.

It will be appreciated that the JSON manifest acts as the single source of truth for an application, structured using a predefined JSON schema that includes roles and permissions, data models, business logic, and UI configuration. Roles and permissions specify user roles and their access levels, while data models define entities, fields, relationships, and constraints. Business logic declares workflows, validation rules, and automation sequences, and UI configuration specifies how data and actions are presented to users. Once defined, the manifest is deployed to the user and various parts of the manifest can be evaluated in real time and modified as necessary. Such modification can be manual, as in the user makes directed edits to the manifest. Alternatively, the manifest can be provided to a LLM or other artificial intelligence platform with additional prompts or context for further review and modification.

In one or more implementations, operations can be performed on portions, or the entire, manifest document. In one arrangement, these supported actions parse the manifest document and instantiate one or more software agents to generate updates to portions of the manifest. The inventors have found that simply tasking an AI agent or other LLM model to revise the manifest in view of additional requirements increases the likelihood that the resulting file is inoperative. Instead, where an adjustment or alteration to the manifest file is necessary, that task is delegated to an AI agent. Importantly, the AI agent is not tasked with regenerating the entire manifest. Instead, the AI agent applies a corrective patch or amendment to the manifest file to update the desired functionality. For example, where an additional field is desired in the generated software application, the AI system is configured to delegate this task to an AI agent. This AI agent generates new JSON content for substitution or integration in the manifest file.

In will be further appreciated that during these updates, it is important to ensure that the new changes to the manifest do not alter the functionality of the generated software. Thus, in one or more arrangements, the validation steps described herein are reimplemented to ensure that these edits to the manifest file match the users intent.

In one or more implementations the manifest file is configured to be evaluated by a software execution platform. In one arrangement, the software execution platform is a separate computing platform from the software generation system 104 and the artificial intelligence platform 106.

In either configuration, one or more processors are configured to evaluate the blueprint or manifest file and generate the necessary code. By way of non-limiting example, the software generation system 104 is configured by a software generation module 214 to receive the manifest file as an input. In one arrangement, the manifest file is a locally stored file. However, in alternative configurations, the manifest file is accessed from a remote data storage location, or a data storage location that is accessible over a network, such as the internet. Using this manifest file, software generation system 104 is configured by a software generation module 214 to parse the manifest file for relevant section of the JSON file. For example, the software generation module 214 configures a processor to identify the portion of the JSON file directed to the user interface generated in step 306d. This parsed JSON file is then translated, converted, compiled, or otherwise utilized to create the corresponding view code for the UI element. Continuing with the example of the user interface portion of the JSON file, the processor is configured by the software generation module 214 to generate HTML, CSS, markdown, or other code that corresponds to the UI content in the JSON file. By way of non-limiting example, the software generation module 214 implements a data-driven software generation process where the JSON file is parsed and provided to a rendering engine or code generator. This rendering engine is configured to generate the necessary code to display the generated user interface. In a particular implementation, the rendering module or engine generates an output file containing HTML and CSS suitable for display on a website. In an alternative implementation, the rendering engine is configured to access an existing HTML and/or CSS file and insert generated code into the existing file(s).

In one arrangement, the software generation server 104 is configured to generate dynamic html based on the manifest contents. For example, the software generation system 104 is configured to use React or another JavaScript library for declarative and component-based user interfaces. It will be appreciated that as with the other high-level concepts in the manifest file, the UI definition codifies common patterns in a data-driven, declarative format that can be interpreted by different software engines. The current example provided is directed to a web application. However, in alternative configurations, the software generation server 104 is configured to generate user interface elements (as well as any other functional elements) for mobile devices (such as using React Native or another framework).

The described software generation system 104 is configurable to provide an expansive set of functions, components and UI patterns. By way of continued example, the manifest file enables the software generation system 104 to declaratively define which patterns are used for which data models. For example, the manifest file can instruct the software generation system 104 to show one or more items from list of items in a table, list, masonry, grid, map, calendar, or other view (or more than one of these, if appropriate for the data). Likewise, the manifest file defines methods for choosing fields in a data model that are more significant than others, fields that should be grouped together, etc.; it defines the page navigation and URLs the app supports. Additionally, the manifest file defines themes that can drastically alter the visual look and feel of the application.

In one particular implementation, one or more LLMs can be utilized to automatically and without human input, define custom UIs that would be defined in the manifest as a pointer to functionality outside the default system, and the LLM is further instructed to generate narrowly scoped UI code which would be injected into the app at runtime.

Once the code has been generated, the corresponding data is integrated or made accessible to the users of the generated software application. For example, a relational database is provided that provides data storage and retrieval in the generated software application. By way of example, data relevant to the application (such as employee data or customer data) is stored within the database, which are accessed through queries. The data is accessed, processed and displayed according to the schema presented in the manifest file, and implemented by html, and other code generated by evaluating the manifest file.

Continuing with the above example, in one or more approaches, the software generation platform 104 is configured to provide access to the corresponding software using a web interface. That is, a user is able to access the software corresponding to the manifest file by access a specific URL or other resource. In a further implementation, the software generation platform 104 is configured to utilize the manifest file to deploy to other targets, such as mobile application repositories or other locations.

In one or more alternative implementations the JSON file is provided to one or more LLMs or other artificial intelligence systems, such as the artificial intelligence appliance 106, as shown in step 310. Here, the software generation server 104 is configured to evaluate the contents of the JSON manifest file. For ease of explanation, the manifest file includes an API layer to process business logic, as well as schema to enforce RBAC, and handle CRUD operations. Here, the AI based software generation system is configured to generate actual API endpoints, automatically creating REST and GraphQL APIs for defined data models based on the direction of the manifest file. The AI based software generation system also enforces role-based access by ensuring API calls are checked against manifest-defined permissions, validates and stores data using constraints and validation rules from the manifest, and executes business logic by interpreting predefined workflows and decision trees stored as structured JSON logic. Additionally, the AI system can invoke custom lambda functions as defined in the manifest for additional business logic. For example, the contents of the JSON file are provided to the artificial intelligence appliance 106, along with other contextual data, such as the type of environment the software will be deployed in (local executable, web access, docker container, etc).

Additionally, the UI layer of the JSON manifest file is used by the machine learning appliance 106 to construct the deployable application's frontend dynamically by reading the manifest. Here, the contents of the JSON file are provided to the artificial intelligence appliance 106, along with other contextual data, so that the artificial intelligence appliance 106 is instructed to generate routes and navigation, defining available views and user navigation. It determines which fields and entities are shown on different screens, configures actions and interactivity such as buttons, filters, and workflows that trigger API calls, and subscribes to live data changes from the API to ensure an always-updated UI.

The software generation server 104 is configured to evaluate the contents of the JSON manifest file. In one configuration, the software generation module 214 is configured to provide information to the machine learning appliance 106 so that the software generated ensures real-time reflection of changes to data or business logic across all components. In one arrangement, such an approach is achieved through the use of WebSockets and event streams that push updates from the API layer to all connected UI clients, state management that caches frequently accessed data and intelligently fetches updates when needed, and version control that tracks changes to the manifest, enabling rollbacks and historical comparisons.

In one configuration, the software generation module 214 configures the software generation system to provide information to the machine learning appliance 106 so that the software generated integrates seamlessly with external databases and APIs, allowing data ingestion and synchronization. In one arrangement, the software generation module 214 provides additional context to the machine learning appliance 106 so that the generated software supports custom UI components, enabling solution specialists to introduce custom components as needed, and lambda functions for extended logic, allowing developers to define custom business logic beyond the JSON manifest file.

Once the software has been generated by the machine learning appliance 1206, it can be deployed for use by the user as shown in step 312. In one arrangement, the deployment is to an executable file (such as a .exe file). However, in other implementations, the software generation module 214 is configured to provide information to the machine learning appliance 106 so that the software generated receives a dedicated deployment. Such dedicated deployment can be either through a locally or remotely hosted cloud service. Likewise, the generated software can be deployed to a private or enterprise server for use by an organization, or to an application store or other distribution channel. It will be appreciated that the generated software is deployed with scalability options based on demand.

By interpreting a structured JSON manifest, the platform delivers a fully functional business application without manual coding. The API layer enforces security and business logic, while the UI layer constructs an interactive experience in real time. This approach allows rapid iteration, scalability, and adaptability for businesses of any size.

The inventors have found that simply instructing an AI system, such as an LLM, to generate the code directly introduces significant errors and unintended functionality. For example, the LLM simply prompted to generate a CRM system may not use industry standard coding conventions or may introduce errors in the code that are hard to identify and debug. As a result, such directly generated software may operate in unforeseen ways, or not function at all. In this case, all that can be done is to have the user manually inspect the code and try to determine where the error has occurred.

In contrast, the described approach includes the generation of a manifest file that details the output from the various component agents. Through the use of specific agents, such as those directed to the generation of an API layer, the manifest file is constructed so that it enforces security and business logic. Similarly, using an AI agent to generate portions of the manifest file for the UI layer constructs an interactive experience in real time. This approach allows rapid iteration, scalability, and adaptability for businesses of any size. In addition to code generation, the described methods include the deployment of the software to various environments, such as web applications.

While the invention has been particularly shown and described with reference to a preferred embodiment thereof, it will be understood by those skilled in the art that various changes in form and details may be made therein without departing from the spirit and scope of the invention.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having the same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter of the present invention have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

Unless the context clearly requires otherwise, throughout the description, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

Publications and references to known registered marks representing various systems are cited throughout this application, the disclosures of which are incorporated herein by reference. Citation of the above publications or documents is not intended as an admission that any of the foregoing is pertinent prior art, nor does it constitute any admission as to the contents or date of these publications or documents. All references cited herein are incorporated by reference to the same extent as if each individual publication and references were specifically and individually indicated to be incorporated by reference.

The above descriptions of embodiments of the present invention are not intended to be exhaustive or to limit the systems and methods described to the precise form disclosed. While specific embodiments of, and examples for, the apparatus are described herein for illustrative purposes, various equivalent modifications are possible within the scope of other articles and methods, as those skilled in the relevant art will recognize. The teachings of articles and methods provided herein can be applied to other devices and arrangements, not only for the apparatus and methods described above.

The elements and acts of the various embodiments described above can be combined to provide further embodiments. These and other changes can be made to the apparatus and methods in light of the above detailed description.

What is claimed

1. A system for generating deployable software, the system comprising:
One or more processors, suitably configured by code stored on a non-transitory medium, to:
receive, a user request for a software application having at least one defined function,
provide the user request and at least one additional contextual instruction for generating a manifest file, to at least one machine learning module;
at least one machine learning system configured to:
generate a plan for generating the manifest file,
delegate execution of at least one portion of the plan to a software agent,
generate a manifest file based on the user request and at least one additional contextual instruction for generating a manifest file, where the manifest file to be generated includes one or more parameters indicative of the functionality of the deployable software;
outputting the generated manifest file;
one or more software generation processors configured by code to,
parse the manifest file,
generate the corresponding executable code, and
provide access to the generated software.

2. The system of claim 1, wherein the manifest file is generated in JSON format.

3. The system of claim 2, wherein the JSON manifest file includes data fields relating to a plurality data structures to be included within the deployable software.

4. The system of claim 1, wherein generating the correspond executable code further includes providing the manifest file to a suitably configured large language model that has been prompted to convert at least a portion of the manifest file into code suitable for inclusion within the deployable software.

5. The system of claim 1, wherein the user input device is configured with a local application that establishes a communication link with the software generation server.

6. The system of claim 1, wherein the software generation server is configured by one or more input modules to pre-process the user input.

7. The system of claim 5, wherein the pre-processing includes converting the user input into a standardized format using one or more natural language processing (NLP) sub-modules.

8. The system of claim 1, wherein generating the at least portion of the manifest file includes instructing a software agent to iteratively regenerate at least a portion of the manifest file based on user feedback.

9. The system of claim 4, wherein the prompts include additional context such as the desired form of the output, additional parameters for consideration, and other relevant information.

10. The system of claim 1, wherein the one machine learning module is configured to access one or more data stores of pre-written context content.

11. A method for generating deployable software, the system comprising:
receiving, by a processor, a user request for a software application having at least one defined function;
providing, by a processor, the user request and at least one additional contextual instruction for generating a manifest file, to at least one machine learning module, wherein the manifest file to be generated includes one or more parameters indicative of the functionality of the deployable software; wherein the at least one machine learning module is further configured generate a plan for generating the manifest file, and further configured to delegate execution of at least one portion of the plan to a software agent;
generating, by the at least one machine learning module at least a portion of the manifest file;
providing, by a processor, at least the generated manifest file to a software generation platform configured to parse the manifest file and generate the corresponding executable code;
providing, by a processor, access to the generated software.

12. The system of claim 11, wherein the software generation module includes providing the manifest file to a pre-trained large language model, trained to generate executable code from manifest files.

13. The system of claim 11, wherein the manifest file is generated in JSON format.

14. A system for dynamically generating deployable software, comprising:
a processor configured to execute code to:
receive, using a user request module, a user request from a remote computing device, wherein the user request includes a request for a deployable software application having specific functionality;
provide to a large language model having access to a data storage repository, the user request, and an instruction to select, from a plurality of software component specifications stored within the data storage device, one or more of:
a software specification for a role-based access control (RBAC) system for use in the requested software application;
a data model planning specification for use in the requested software application;
a controller specification;
an API design specification configured to generate API endpoints and controller actions; and
a UI and layout generation specification; and
generate a manifest file based on the selected one or more software component specifications.

15. The system of claim 14, further comprising a software generation module that configures the processor to generate the deployable software based on the generated manifest file.

16. The system of claim 14, wherein the manifest file is generated in JSON format.
